(19) United States
(12) Patent Application Publication
(10) Pub. No.: US 2026/0370899 A1
(43) Pub. Date: Nov. 19, 2026

(54) CREATING A CHANNEL OF VIDEO EXPERIENCES TAILORED TO A USER

(71) Applicant: Google LLC, Mountain View, CA (US)

(72) Inventors: Aravind Reddy Ayuluri, San Jose, CA (US); Prameela Kavya Thummuru, San Jose, CA (US)

(21) Appl. No.: 19/206,873

(22) Filed: May 13, 2025

(51) Int. Cl. H04N 21/2668; H04N 21/258; H04N 21/414

(52) U.S. Cl. CPC H04N 21/2668; H04N 21/25841; H04N 21/25883; H04N 21/41407

(57) ABSTRACT

According to an aspect, a method may include obtaining, by a server computer, data related to preferences of a user and obtaining, by the server computer and from a computing device, contextual information related to the user. The method may include obtaining demographic data related to the user, and generating, by the server computer, a prompt for use by a large language model that is based on the data related to preferences of the user, the contextual information related to the user, and the demographic data related to the user. The method may include sending the prompt to the large language model, obtaining, by the server computer and from a customized content repository, a customized media content item for the user generated by the large language model based on the prompt, and sending the customized media content item to the computing device for playing on the computing device.

### BACKGROUND

A television (TV) application may present various types of media content of interest to a user. The media content may have different formats such as streaming video and audio. The types of media content may include, but are not limited to, movies, television shows, sporting events, news items, short form videos, and music. In addition, or in the alternative, a variety of media content providers may deliver various types of media content for viewing by the user. The TV application may deliver a customized viewing experience to a user that spans the diverse types of media content provided by the variety of media content providers.

### SUMMARY

In some aspects, the techniques described herein relate to a method including: obtaining, by a server computer, data related to preferences of a user; obtaining, by the server computer and from a computing device, contextual information related to the user; obtaining demographic data related to the user; generating, by the server computer, a prompt for use by a large language model that is based on the data related to preferences of the user, the contextual information related to the user, and the demographic data related to the user; sending the prompt to the large language model; obtaining, by the server computer and from a customized content repository, a customized media content item for the user generated by the large language model based on the prompt; and sending the customized media content item to the computing device for playing on the computing device.

In some aspects, the techniques described herein relate to a method, wherein the data related to preferences of the user is obtained from a user data repository.

In some aspects, the techniques described herein relate to a method, wherein the contextual information includes at least one of an Internet Protocol (IP) address of the computing device, a language of use by the computing device, and Global Positioning System (GPS) coordinates for the computing device.

In some aspects, the techniques described herein relate to a method, further including sending the customized media content item to an advertising stitcher that inserts at least one advertisement into the customized media content item.

In some aspects, the techniques described herein relate to a method, further including: receiving an event trigger; and based on receiving the event trigger, triggering the generating of the prompt.

In some aspects, the techniques described herein relate to a method, wherein the prompt is generated without input from the user.

In some aspects, the techniques described herein relate to a method, wherein the computing device is a first computing device of the user; wherein the contextual information related to the user includes information associated with the first computing device; wherein the customized media content item for the user generated by the large language model based on the prompt is a first customized media content item; and wherein sending the customized media content item to the computing device for playing on the computing device includes sending the first customized media content item to the first computing device for playing on the first computing device.

In some aspects, the techniques described herein relate to a method, wherein the computing device is a second computing device of the user different from the first computing device; and wherein the contextual information related to the user includes information associated with the second computing device; wherein the customized media content item for the user generated by the large language model based on the prompt is a second customized media content item; and wherein sending the customized media content item to the computing device for playing on the computing device includes sending the second customized media content item to the second computing device for playing on the second computing device.

In some aspects, the techniques described herein relate to a method, wherein the first computing device is a smart television and the second computing device is a mobile computing device.

In some aspects, the techniques described herein relate to a method, further including: receiving, by the server computer and from the computing device, at least one parameter associated with the user; and based on receiving the at least one parameter associated with the user, generating, by the server computer, an updated prompt for use by the large language model based on the data related to preferences of the user, the contextual information related to the user, the demographic data related to the user, and the at least one parameter.

In some aspects, the techniques described herein relate to a non-transitory computer-readable medium storing executable instructions that when executed by at least one processor of a server computer cause the at least one processor to execute operations, the operations including: obtaining, by the server computer, data related to preferences of a user; obtaining, by the server computer and from a computing device, contextual information related to the user; obtaining demographic data related to the user; generating a prompt for use by a large language model that is based on the data related to preferences of the user, the contextual information related to the user, and the demographic data related to the user; sending the prompt to the large language model; obtaining, by the server computer and from a customized content repository, a customized media content item for the user generated by the large language model based on the prompt; and sending the customized media content item to the computing device for playing on the computing device.

In some aspects, the techniques described herein relate to a non-transitory computer-readable medium, wherein the data related to preferences of the user is obtained from a user data repository.

In some aspects, the techniques described herein relate to a non-transitory computer-readable medium, wherein the contextual information includes at least one of an Internet Protocol (IP) address of the computing device, a language of use by the computing device, and Global Positioning System (GPS) coordinates for the computing device.

In some aspects, the techniques described herein relate to a non-transitory computer-readable medium, further including sending the customized media content item to an advertising stitcher that inserts at least one advertisement into the customized media content item.

In some aspects, the techniques described herein relate to a non-transitory computer-readable medium, wherein the operations further include: receiving an event trigger; and based on receiving the event trigger, triggering the generating of the prompt.

In some aspects, the techniques described herein relate to a system including: at least one processor; and a non-transitory computer-readable medium storing instructions that when executed by the at least one processor cause the system to: obtain data related to preferences of a user; obtain contextual information related to the user; obtain demographic data related to the user; generate a prompt for use by a large language model that is based on the data related to preferences of the user, the contextual information related to the user, and the demographic data related to the user; send the prompt to the large language model; obtain a customized media content item for the user generated by the large language model based on the prompt; and send the customized media content item to a computing device for playing on the computing device.

In some aspects, the techniques described herein relate to a system, wherein the data related to preferences of the user is obtained from a user data repository.

In some aspects, the techniques described herein relate to a system, wherein the contextual information includes at least one of an Internet Protocol (IP) address of the computing device, a language of use by the computing device, and Global Positioning System (GPS) coordinates for the computing device.

In some aspects, the techniques described herein relate to a system, further including sending the customized media content item to an advertising stitcher that inserts at least one advertisement into the customized media content item.

In some aspects, the techniques described herein relate to a system, wherein the instructions when executed by the at least one processor further cause the system to: receive an event trigger; and based on receiving the event trigger, trigger the generating of the prompt.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example of a user interacting with a network-connected display device to select a my channel option according to implementations described throughout this disclosure.

FIG. 1B illustrates an example of a user interface displayed on the network-connected display device 104 in response to a selection of a my channel by a user according to implementations described throughout this disclosure.

FIG. 1C is an illustration of an example of a customized media content recommendation system for generating customized media content for including in a customized channel of a television application according to implementations described throughout this disclosure.

FIGS. 2A-H illustrate example details of the customized media content recommendation system according to implementations described throughout this disclosure.

FIG. 3 is an illustration of an example swimlane diagram showing steps of a process for obtaining information and data related to media content selected for viewing by a user according to implementations described throughout this disclosure.

FIG. 4 is an illustration of an example swimlane diagram showing steps of a process for generating customized media content for a user according to implementations described throughout this disclosure.

FIG. 5 is an illustration of an example swimlane diagram showing steps of a process for providing a selection of customized media content to a television application for viewing by a user according to implementations described throughout this disclosure.

FIG. 6 is an illustration of an example static prompt that includes a parameterized template according to implementations described throughout this disclosure.

FIG. 7 is an illustration of an example model-based prompt according to implementations described throughout this disclosure.

FIG. 8 illustrates a flowchart depicting example operations of generating customized media content according to implementations described throughout this disclosure.

### DETAILED DESCRIPTION

A television (TV) application may provide a user with recommended media content for viewing by the user. The TV application may interface with a media content recommendation system that may offer suggestions for media content that a user may be interested in viewing based on, for example, the past viewing habits of the user. The media content recommendation system may, however, fail to provide an engaging viewing experience to the user that could be provided by customizing the recommended media content for the user. In addition, or in the alternative, the media content recommendation system, when offering suggestions for media content that a user may be interested in viewing, may not fully consider that the user may watch diverse media content across various genres. In addition, or in the alternative, the media content recommendation system, when offering suggestions for media content that a user may be interested in viewing, may not fully consider that the user may have fluctuating interests during a period of time (e.g., a year). In general, a challenge for a media content recommendation system may be how to synthesize the diverse preferences of the user into a single, cohesive, and customized entertainment offering while providing some variety to the recommended media content.

A technical problem may be the implementation of a media content recommendation system that provides customized entertainment offerings to a user as a custom channel in a TV application. In addition, or in the alternative, a technical problem for the media content recommendation system may be how to determine and then synthesize the diverse preferences of the user into customized entertainment offerings on the custom channel.

A technical solution may include a media content recommendation system utilizing generative artificial intelligence (AI) to create the custom channel of video experiences tailored to the user. In some implementations, the media content recommendation system may analyze a viewing history of a user while interacting with a TV application. The media content recommendation system may determine one or more preferences of the user for media content for particular genres. The media content recommendation system may determine patterns for media content watched by the user, such as for example, the user may watch adult movies on Saturday nights, and kid movies on Friday nights.

A technical solution may include the media content recommendation system enhancing a viewing experience of the user by generating customized media content. The customized media content may be based on the previous viewing behavior of the user. The media content recommendation system may generate multiple customized media content items (e.g., videos, short form videos, movies, etc.) featuring the user as the protagonist. For example, a generated customized media content item may focus on different combinations of the genres related to previous media content watched by the user. In addition, or in the alternative, the customized media content item may include an avatar of the user and/or the voice of the user when including the user as the protagonist or lead character in the customized media content item.

A technical effect may include the media content recommendation system leveraging the use of generative AI to create a channel of video experiences for including in a TV application that is customized and tailored to a user based on the viewing history of the user over a period of time when interacting with the TV application.

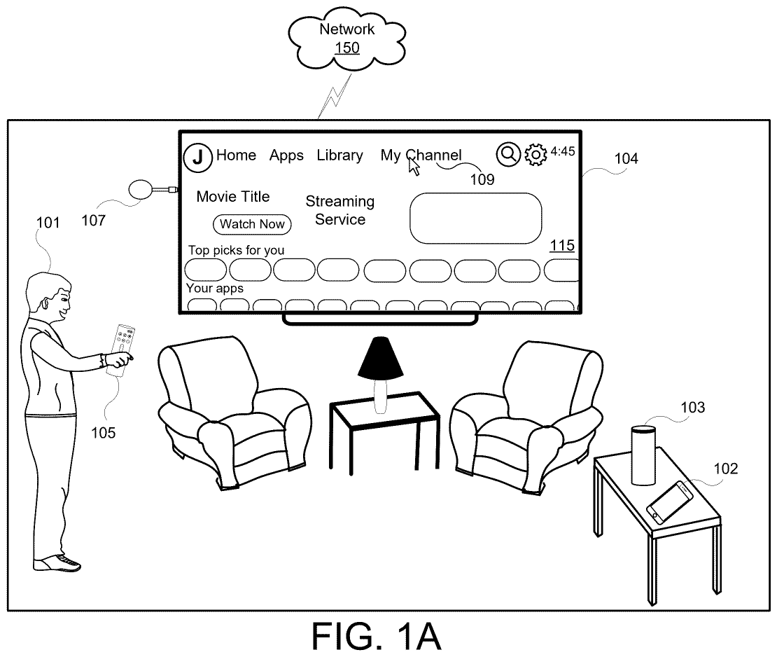

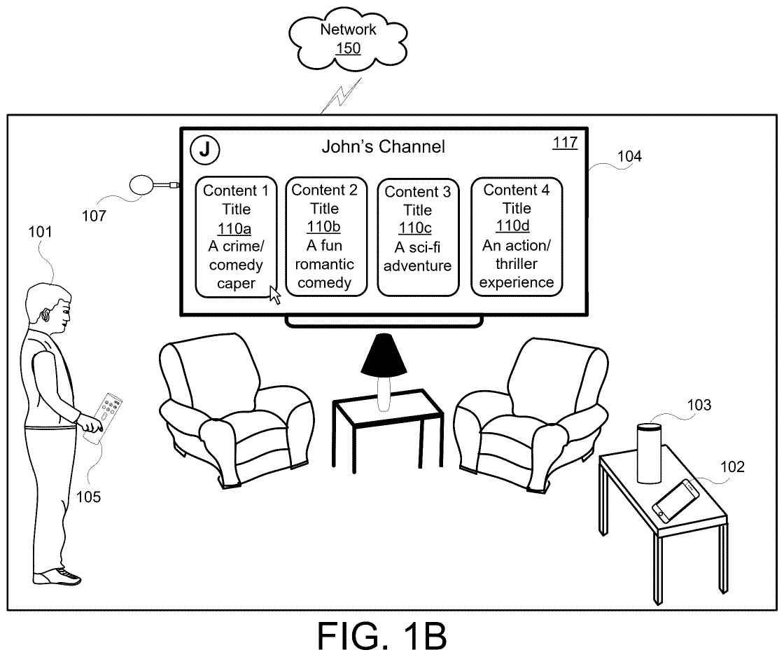

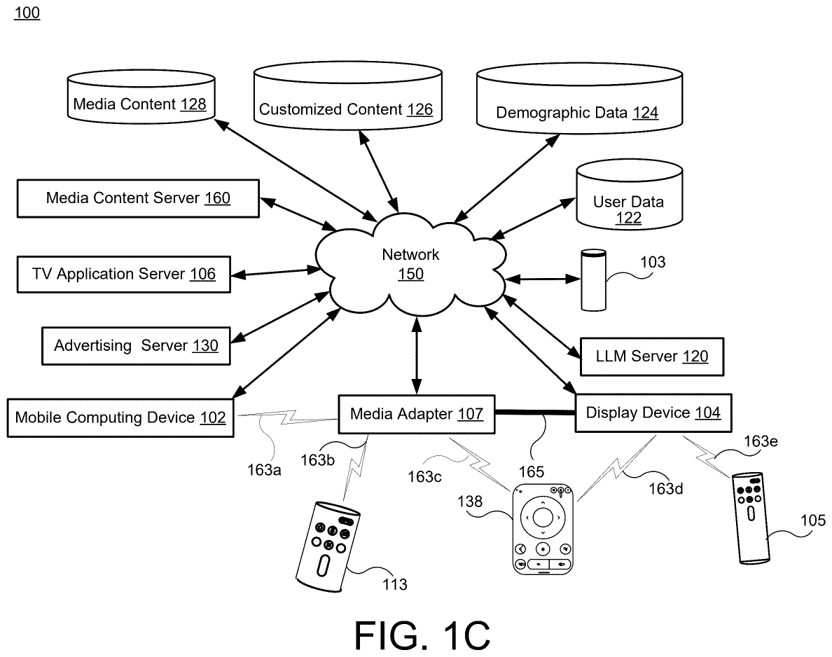

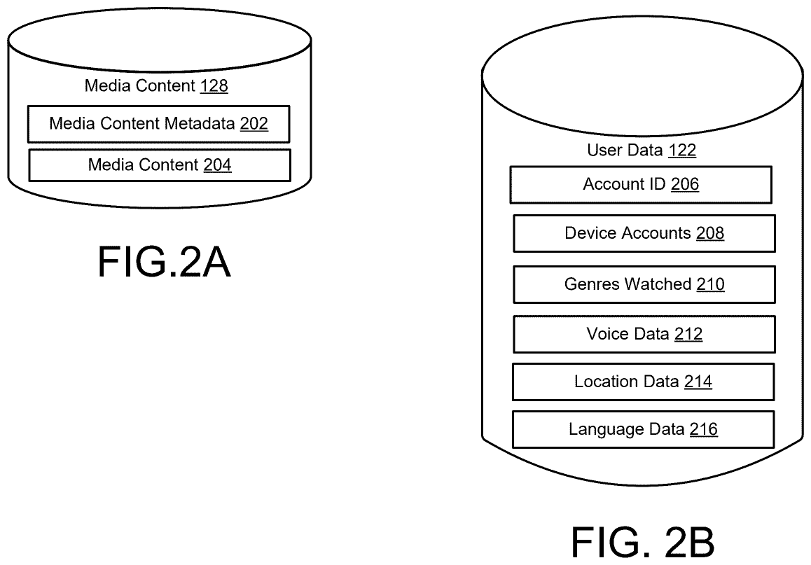

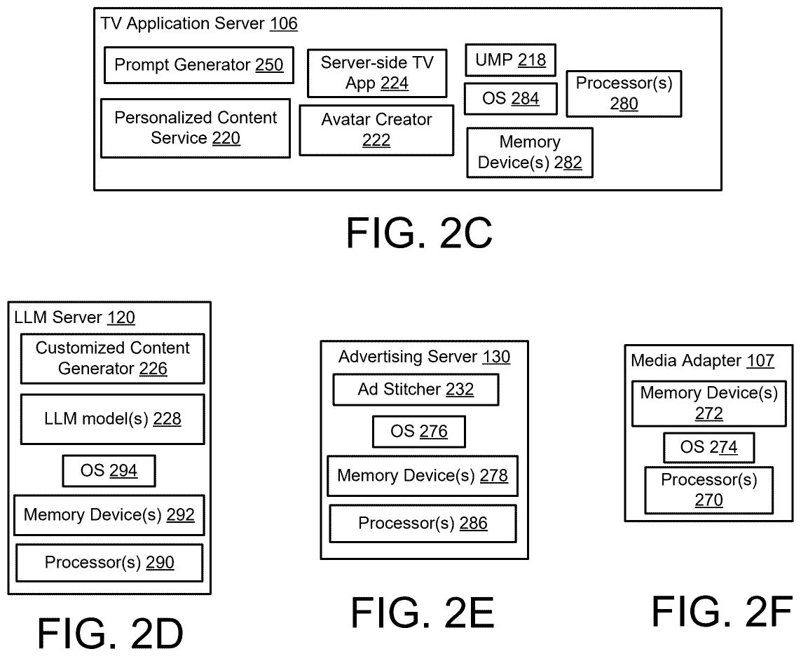

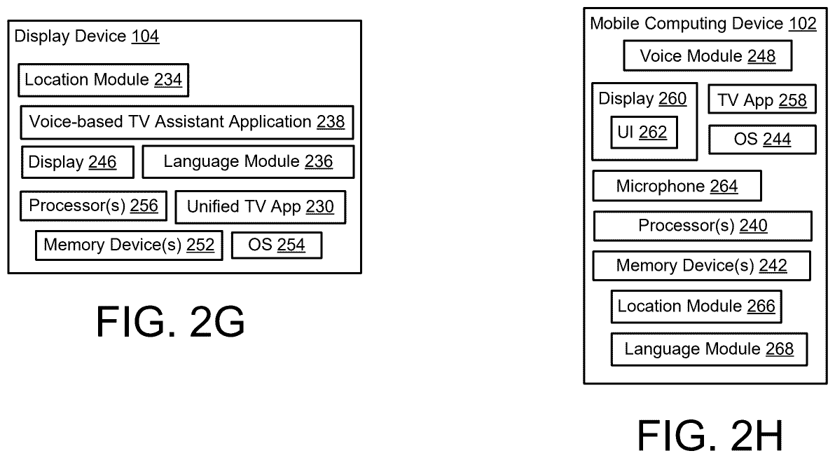

FIG. 1A illustrates an example of a user 101 interacting with a network-connected display device 104 to select a my channel option 109 according to implementations described throughout this disclosure. FIG. 1B illustrates an example of a user interface 117 displayed on the network-connected display device 104 in response to a selection of a my channel option (e.g., the my channel option 109) by a user (e.g., the user 101) according to implementations described throughout this disclosure. FIG. 1C is an illustration of an example of a customized media content recommendation system 100 for generating customized media content for including in a customized channel of a television (TV) application (e.g., unified television application 230 as shown in FIG. 2G) according to implementations described throughout this disclosure. FIGS. 2A-H illustrate example details of the customized media content recommendation system 100 according to implementations described throughout this disclosure.

Referring to FIGS. 1A-C and 2A-H, the network-connected display device 104 may communicate with a television (TV) application server 106 and media content providers 160 by way of the network 150. The media content providers 160, a media content repository 128, the network-connected display device 104, the media adapter 107, the television application server 106, a mobile computing device 102, a large language model (LLM) server 120, and an advertising server 130 may interact and communicate with one other by way of the network 150. In some implementations, the mobile computing device 102 may interface or connect to the media adapter 107 and/or the network-connected display device 104 by way of a wireless communication link that may be a short-range wireless connection such as, for example, a Bluetooth connection or a Wi-Fi (e.g., direct Wi-Fi) connection.

Referring to FIG. 1C, the media content providers 160 may be interfaced or communicatively coupled to the media content repository 128. In some implementations, the media content providers 160 may receive a request for media content stored in the media content repository 128 and, in response, may send or provide the requested media content from the media content repository 128 to the requestor. In some implementations, the LLM server 120, the network-connected display device 104, the media adapter 107, the mobile computing device 102, the advertising server 130, and/or the television application server 106 may fetch or obtain media content from the media content repository 128 using a Uniform Resource Locator (URL) provided by a media content provider of the media content providers 160.

In some implementations, referring to FIG. 2C, the user 101 may connect to and interact with the media adapter 107 by way of the network-connected display device 104 using a server-side television (TV) application 224 installed on the television application server 106. The media adapter 107 may be connected or interfaced to the network-connected display device 104. The network-connected display device 104 may be communicatively coupled or connected to the television application server 106 by way of the network 150. A unified media platform (UMP) 218 included on the television application server 106 may interface with the unified television application 230 executing on the network-connected display device 104 and the media content providers 160. In these implementations, the UMP 218 may provide or serve media content items from the media content providers 160 to the network-connected display device 104 by way of the media adapter 107. In some implementations, the UMP 218 may provide or serve media content items from a customized content repository 126 to the network-connected display device 104 by way of the media adapter 107. The customized content repository 126 may store customized media content for users.

In some implementations, the user 101 may connect to and interact with the media adapter 107 using the television (TV) application 258 installed on the mobile computing device 102. In some implementations, the user 101 may connect to and interact with the media adapter 107 using a media adapter remote control device 113. In some implementations, the TV application 258 may render the virtual remote control 138 for use with the media adapter 107. The virtual remote control 138 may allow the mobile computing device 102 to act as a remote control for the media adapter 107. The user 101 may interact with the virtual remote control 138 and/or the media adapter remote control device 113 when interacting with the media adapter 107.

In some implementations, referring to FIG. 2H, the user 101 may interact with the network-connected display device 104 using a remote control device 105. In some implementations, the TV application 258 running on the mobile computing device 102 may render a virtual remote control 138 in a user interface (e.g., UI 262) on a display (e.g., a mobile computing device display 260) on the mobile computing device 102. The virtual remote control 138 may allow the mobile computing device 102 to act as a remote control for the network-connected display device 104. The TV application 258 may render the virtual remote control 138 for use with the network-connected display device 104.

In some implementations, the voice-based TV assistant application 238 may receive voice data or commands from the mobile computing device 102 when acting as a remote control for the network-connected display device 104. For example, referring to FIG. 2H, a microphone 264 included on the mobile computing device 102 may receive verbal commands or voice data from the user 101. In some implementations, a voice module 248 may send the voice data to the network-connected display device 104 by way of the network 150. In some implementations, the voice module 248 may send the voice data to the network-connected display device 104 by way of a wireless communication link (e.g., wireless communication link 163d).

A user may speak into a voice input device providing voice data as spoken words (e.g., human speech). The voice-based television assistant application 238 may receive voice data from the voice input devices. The voice-based TV assistant application 238 may process the voice data or human speech to provide textual input (input text) as a sequence of words to the unified television application 230 running on the network-connected display device 104. The network-connected display device 104 may execute the unified television application 230. The unified television application 230 may interface with a server-side television (TV) application 224.

For example, the user 101 may launch the unified television application 230. The unified television application 230 may provide a user interface 115 on a display 246 of the network-connected display device 104. In some implementations, the voice-based TV assistant application 238 may perform natural language processing on the voice data to convert the human speech into the sequence of words. In some implementations, the voice-based TV assistant application 238 may be included in a smart speaker 103. In some implementations, the voice-based TV assistant application 238 may be included in the remote control device 105. In some implementations, the voice-based TV assistant application 238 may be included in the voice module 248 on the mobile computing device 102. The sequence of words may be input text representative of the verbal input received by the voice input device.

In some implementations, the voice-based TV assistant application 238 may store the voice data in memory device(s) 252 included on the network-connected display device 104. In some implementations, referring to FIG. 2C, the voice-based TV assistant application 238 may provide the voice data to the television application server 106 for storage in memory device(s) 282 in association with the user. As will be described further herein, the media content recommendation system 100 may use the voice data when generating customized media content for the user 101.

The customized media content recommendation system 100 may obtain information and data related to the media content viewing history of a user (e.g., the user 101) along with, in some implementations, a digital representation of the user and voice data for the user. In some implementations, the information and data may be obtained over a period of time. Examples of time periods may include, but are not limited to, a week, a month, a number of months, and a year. The information and data related to the media content viewing of the user 101 may include, but is not limited to, TV shows watched by the user, movies watched by the user, and short form videos watched by the user.

In addition, or in the alternative, the information and data related to the media content viewing of a user (e.g., the user 101) may include metadata associated with the media content that may include, but is not limited to, genre, actors, and themes. Referring to FIGS. 1C and 2A, for each media content item stored in the media content repository 128, the media content repository 128 may include media content 204 along with associated media content metadata 202. Referring to FIGS. 1C and 2D, in some implementations, a machine learning model (e.g., a large language model included in large language model(s) (LLM(s) 228) in the LLM server 120) may receive or obtain information and data related to the media content viewing of the user from a user data repository 122 and/or a demographic data repository 124. The user data repository 122 may include information and data related to the media content viewing of the user. The demographic data repository 124 may include demographic information and demographic data related to the media content viewing of one or more demographics associated with the user.

The machine learning model may use the information and data related to the media content viewing of a user (e.g., the user 101) to perform genre synthesis and clustering. In some implementations, the machine learning model may analyze the viewing history of the user to determine genres of interest to the user and the relative importance of each genre to the user. The machine learning model may cluster the genres into one or more genre groups based on, for example, the compatibility and potential for narrative synergy for the genres in each group. For example, the machine learning model may group crime, thriller, and action genres into a first genre group. In another example, the machine learning model may group comedy, romance, and drama genres into a second genre group. In some implementations, the machine learning model may recommend generated media content for the one genre group over generated media content for another genre group based on the determined relative importance of each genre included in the genre groups to the user. For example, the machine learning model may recommend the first genre group over the second genre group based determining that the user prefers watching media content in crime, thriller, and action genres over media content in comedy, romance, and drama genres.

The LLM server 120 may include a customized content generator 226. The customized content generator 226 may use a generative AI model (e.g., a large language model included in the LLM(s) 228) to generate customized media content based on a genre group. The generated customized media content may include elements from the genres included in the genre group. For example, to offer a user a variety of customized media content, the customized content generator 226 may generate multiple media content items based on one genre group. In addition, or in the alternative, the customized content generator 226 may generate multiple media content items based on a genre group for each genre group for the user.

The customized media content recommendation system 100 may obtain information and data related to the media content viewing history of a user (e.g., the user 101) along with, in some implementations, a digital representation of the user and voice data for the user. In some implementations, the customized content generator 226 may use visual and/or audio information and data for the user when representing the user in the customized media content. For example, the television application server 106 in the media content recommendation system 100 may include a user representation creator 222. For example, the user representation creator 222 may receive visual data for the user (e.g., photos, videos, etc. of the user) from the mobile computing device 102. For example, the user representation creator 222 may obtain visual data for the user (e.g., photos, videos, etc. of the user) from the user data repository 122. The user representation creator 222 may use visual data for the user to create a digital representation of the user (e.g., an avatar of the user) for use by the customized content generator 226 when generating customized media content. The customized content generator 226 may receive the digital representation of the user and may use the digital representation of the user as an image for a protagonist in the generated customized media content. For example, the television application server 106 in the media content recommendation system 100 may include a customized content service 220. The customized content service 220 may receive audio data (e.g., voice data for the user). The customized content service 220 may provide or send the audio data to the customized content generator 226. The customized content generator 226 may synthesize the voice of the user for the dialogue of a protagonist in the customized media content. The customized content generator 226 may use a generative AI model included in the LLM(s) 228 to combine a generated story based on the genre group, a digital representation of the user, and the audio data for the user to generate one or more customized media content items for the user.

The customized content generator 226 may store the customized media content for a user (e.g., the user 101) in the customized content repository 126 in association with the user. For example, referring to FIGS. 1A-B, the unified television application 230 may present the my channel option 109 in the user interface 115 of the unified television application 230 on the display 246 of the network-connected display device 104. The user 101 interacting with the remote control device 105 may select the my channel option 109. In response to the selection of the my channel option 109, the unified television application 230 may present a customized channel (e.g., “John's Channel”) in the user interface 117 on the display 246 of the network-connected display device 104. The user interface 117 may include a selection of the generated customized media content items displayed as tiles 110a-d for selection by the user 101. For example, a tile (e.g., tiles 110a-d) may include a title for the customized media content item and a description for the media content item. The description for a media content item may include a genre or genre blend for the media content item. (e.g., “Content Title 1—a crime/comedy caper”).

Referring to FIGS. 1C and 2B, the user data repository 122 may store information and data in association with a user. The user data repository 122 may store the information and data per an account of a user and per a device of the user. For example, the user 101 may log into an account of the user 101 by way of the mobile computing device 102 communicating or interfacing with the television application server 106. In addition, or in the alternative, the user 101 may log into the account of the user 101 by way of the network-connected display device 104 communicating or interfacing with the television application server 106. For example, referring to FIG. 2H, the user 101 may launch the TV application 258 on the mobile computing device 102. The user 101 may log into an account of the user 101 for the TV application 258. The user 101 may interact with the TV application 258. In another example, referring to FIG. 2G, the user 101 may launch the unified television application 230 on the network-connected display device 104. The user 101 may log into an account of the user 101 for the unified television application 230. The information and data related to the user 101 may then be periodically sent, pushed, or provided to the television application server 106 for storage in the user data repository 122. The information and data related to the user 101 may be usage and viewing history of the user 101 in association with the account of the user and the computing device providing the information and data (e.g., the mobile computing device 102 and the network-connected display device 104).

The information and data that the television application server 106 may receive from one or more computing devices of a user (e.g., the mobile computing device 102 and the network-connected display device 104) may include, but is not limited to, an account identifier (ID) 206, device accounts 208, genres watched 210, voice data 212, location data 214, and language data 216. For example, the account ID 206 may include a name for the user, an image or picture of the user, and/or an age demographic for the user.

For example, the user representation creator 222 may use the image or picture of the user to create a digital representation of the user). For example, the device accounts 208 may include information and data related to other user accounts that may use the same computing device. For example, the information and data related to the other accounts may include an age demographic for the other user (e.g., is the other user elderly (e.g., over 65 years of age), is the other user a child (e.g., under the age of 13 years)). The information and data for the other user may be used to fine tune recommended customized media content for providing to the user in a customized channel for the user.

For example, the genres watched 210 may include, but is not limited to, a watch time for a media content item and a title for a watched media content item. For example, the user 101 may watch media content on the network-connected display device 104. The unified television application 230 may send or provide a watch time for the media content item along with a title for the media content item to the server-side TV application 224. The server-side TV application 224 may provide the watch time for the media content item along with the title for the media content item to the customized content service 220. The customized content service 220 may interface with the media content repository 128 to access the media content metadata 202 for the media content item of the received title to determine a genre for the media content item. The customized content service 220 may store the determined genre in the genres watched 210 in the user data repository 122.

In some implementations, the unified television application 230 may send or provide a watch time for one or more periods, sections, chapters, or parts of the media content item along with a title for the media content item to the server-side TV application 224. The server-side TV application 224 may provide the watch times for the determined periods of the media content item along with the title for the media content item to the customized content service 220. The customized content service 220 may interface with the media content repository 128 to access the media content metadata 202 for the media content item of the received title to determine a genre for each period of the media content item. The customized content service 220 may determine a genre for each watched period of the media content item. Genre detection for a media content item may be improved by determining a genre for each watched period of the media content item and storing the genre for the largest number of watched periods as the genre of interest to the user. For example, a user is watching a media content item that is a horror comedy movie. If the user watched durations, sections, or periods of the horror comedy movie are associated with a comedy genre more than the watched durations, sections, or periods of the horror comedy movie are associated with a horror genre, the customized content service 220 may store the comedy genre in the genres watched 210 in the user data repository 122 as the genre associated with the media content item.

In some implementations, referring to FIG. 2G and as described herein, the voice-based TV assistant application 238 may send or provide voice data to the server-side TV application 224 on the television application server 106. The server-side TV application 224 may store the voice data in the voice data 212 in the user data repository 122. For example, the customized content service 220 may access the voice data 212 and provide the voice data 212 to the customized content generator 226 for use in generating customized media content for the user.

In some implementations, referring to FIG. 2H and as described herein, the voice module 248 may send or provide voice data to the server-side TV application 224 on the television application server 106. The server-side TV application 224 may store the voice data in the voice data 212 in the user data repository 122. For example, the customized content service 220 may access the voice data 212 and provide the voice data 212 to the customized content generator 226 for use in generating customized media content for the user.

In some implementations, referring to FIG. 2G, a location module 234 may interface with the unified television application 230. The location module 234 may provide location information and data for the network-connected display device 104 to the unified television application 230. For example, the location information and data may be input to a settings option for the unified television application 230 executing on the network-connected display device 104. For example, the location information and data may be Global Positioning System (GPS) coordinates used to determine a geographic location for the network-connected display device 104. For example, the location information and data may be an Internet Protocol (IP) address of the network-connected display device 104. The IP address may be used to determine a general geographic location for the network-connected display device 104.

The unified television application 230 may send or provide the location information and data to the server-side TV application 224. The server-side TV application 224 may store the location information and data in the location data 214 in the user data repository 122. For example, the customized content service 220 may access the location data 214 and provide the location data 214 to the customized content generator 226 for use in generating customized media content for the user.

In some implementations, referring to FIG. 2H, a location module 266 may interface with the TV application 258. The location module 266 may provide location information and data for the mobile computing device 102 to the unified television application 230. For example, the location information and data may be input to a settings option for the TV application 258 executing on the mobile computing device 102. For example, the location information and data may be Global Positioning System (GPS) coordinates used to determine a geographic location for the mobile computing device 102. For example, the location information and data may be an Internet Protocol (IP) address of the mobile computing device 102. The IP address may be used to determine a general geographic location for the mobile computing device 102.

The TV application 258 may send or provide the location information and data to the server-side TV application 224. The server-side TV application 224 may store the location information and data in the location data 214 in the user data repository 122. For example, the customized content service 220 may access the location data 214 and provide the location data 214 to the customized content generator 226 for use in generating customized media content for the user.

In some implementations, referring to FIG. 2G, a language module 236 may interface with the unified television application 230. The language module 236 may provide the default language setting for the network-connected display device 104 to the unified television application 230. For example, language information and data may be input to a settings option for the unified television application 230 executing on the network-connected display device 104. For example, the language information and data may be a setting for the network-connected display device 104. The unified television application 230 may send or provide the language information and data to the server-side TV application 224. The server-side TV application 224 may store the language information and data in the language data 216 in the user data repository 122. For example, the customized content service 220 may access the language data 216 and provide the language data 216 to the customized content generator 226 for use in generating customized media content for the user.

In some implementations, referring to FIG. 2H, a language module 268 may interface with the TV application 258. The language module 268 may provide the default language setting for the mobile computing device 102 to the TV application 258. For example, language information and data may be input to a settings option for the TV application 258 executing on the mobile computing device 102. For example, the language information and data may be a setting for the mobile computing device 102. The TV application 258 may send or provide the language information and data to the server-side TV application 224. The server-side TV application 224 may store the language information and data in the language data 216 in the user data repository 122. For example, the customized content service 220 may access the language data 216 and provide the language data 216 to the customized content generator 226 for use in generating customized media content for the user.

In some implementations, a user may initiate the generating of customized media content for a customized channel for the user. For example, the user may access a settings option for the unified television application 230 that may initiate the generating of the customized media content for the customized channel for the user. In some implementations, the server-side TV application 224 included in the television application server 106 may initiates the generating of customized media content for a user based on a time period (e.g., weekly, monthly, yearly). The server-side TV application 224 may initiate the generating of customized media content for a customized channel for the user by fetching or obtaining information and data associated with the user from the user data repository 122 and providing the information and data associated with the user to the customized content service 220. The customized content service 220 may provide the information and data associated with the user to a prompt generator 250. The prompt generator 250 may use the information and data associated with the user to create a prompt. The prompt generator 250 may send or provide the prompt to the LLM server 120. The LLM server 120 may provide the prompt to the customized content generator 226 for use by the customized content generator 226 along with the LLM(s) 228 to generate customized media content for playing on a computing device for viewing by a user in a customized channel of a TV application (e.g., the TV application 258, the unified television application 230) executing on the computing device (e.g., the mobile computing device 102, the network-connected display device 104, respectively) of the user.

Referring to FIGS. 1C and 2A-H, the mobile computing device 102 may be configured to execute the TV application 258. The mobile computing device 102 may include the mobile computing device display 260 configured to display the UI 262. A user may interact with the UI 262 to set up, control, and interact with the TV application 258. In some implementations, as described, the TV application 258 may display the virtual remote control 138 in the UI 262 allowing the user 101 to interact with and control the network-connected display device 104 and/or the media adapter 107.

The mobile computing device 102 may be any type of computing device that includes one or more processors (processor(s) 240), one or more memory devices (memory device(s) 242), and an operating system 244. The mobile computing device 102 may be a smartphone, a tablet, a wearable device, a laptop computer, or a desktop computer. In some implementations, the operating system 244 may be system software that manages computer hardware, software resources, and provides common services for computing programs.

In some implementations, the mobile computing device 102 may be a tablet, a smartphone, or a wearable. In these implementations, the operating system 244 may be referred to as a mobile operating system. The mobile operating system may be configured to execute on devices that, in general, include display devices that may be smaller in size than, for example, a display device included in a laptop computer or a desktop computer. In some implementations, the mobile computing device 102 may be a laptop computer. In these implementations, the operating system may be referred to as a laptop or desktop operating system. In these implementations, the operating system 244 may be an operating system designed for a display that is larger in size than that included in a tablet, a smartphone, or a wearable.

In some implementations, the media adapter 107 (e.g., a casting device, a media streaming device, a media streaming player, a set-top box) may be interfaced with or connected to the network-connected display device 104. The media adapter 107 may interact with and communicate with the media content providers 160, the television application server 106, and the mobile computing device 102 when providing media content to the network-connected display device 104. In some implementations, the media adapter 107 may be embedded in and/or an integrated part of the network-connected display device 104.

The media content providers 160 may include a variety of streaming service and media content sources and service platforms. The media adapter 107 may facilitate providing (e.g., streaming) media content (e.g., streaming video such as movies, TV shows, etc.) from one or more streaming services included in the media content providers 160 to the network-connected display device 104. For example, the media adapter 107 may directly connect to a connector on the network-connected display device 104 by way of connection 165. The media adapter 107 may provide digital video and/or audio to the network-connected display device 104. For example, the media adapter 107 may connect to a high-definition multimedia interface (HDMI) connector included in the network-connected display device 104. Examples of the media adapter 107 may include, but are not limited to, a set-top box, a television box, and a streaming media adapter.

In some implementations, the mobile computing device 102 may connect to or interface with the media adapter 107 by way of a wireless communication link 163b. Wireless communication links 163a-e may be short-range wireless connections such as a Bluetooth connection. In some examples, wireless communication links 163a-e may be a Wi-Fi (e.g., direct Wi-Fi) connection.

The media adapter 107 may be any type of computing device that includes one or more processors (processor(s) 270), one or more memory devices (memory device(s) 272), and an operating system 274. In some implementations, the processor(s) 270 may include a system on a chip (SoC). The SoC may include a central processing unit (CPU), a graphic processing unit (GPU), one or more memory interfaces, and one or more input/output interfaces and devices. In some implementations, the operating system 274 may be system software that manages computer hardware, software resources, and provides common services for computing programs.

The network-connected display device 104 may include the unified television application 230. The unified television application 230 may keep a record of the interactions of the user with the media content received from the television application server 106. The network-connected display device 104 may send the record of the interactions to the television application server 106 for use in determining media content recommendations for the user. In addition, or in the alternative, the television application server 106 may use the record of the interactions when generating customized media content for the user.

In some implementations, the network-connected display device 104 may be configured to execute the unified television application 230. For example, the network-connected display device 104 may be a smart television. For example, a smart television may be a network-connected television that may connect to media content providers (e.g., media content providers 160) by way of a network (e.g., the network 150). The media content providers may source media content to the smart television. In these implementations, a user may interact with the unified television application 230 to access media content from the media content providers 160. The unified television application 230 may interface with the television application server 106, and specifically with the server-side TV application 224. The unified television application 230 may provide similar functionality to the user as that provided by an application executing on the media adapter 107. For example, executing the unified television application 230 by the network-connected display device 104 allows the network-connected display device 104 to obtain a media content recommendation stream from the television application server 106.

The network-connected display device 104 may be configured to connect to the network 150. In some implementations, the network-connected display device 104 is a television (e.g., a smart television (TV)). The network-connected display device 104 may include one or more processors (processor(s) 256), one or more memory devices (memory device(s) 252), and an operating system (OS) 154. The operating system 254 may execute (or assist with executing) the unified television application 230.

In some implementations, the operating system 254 may be a browser application. A browser application is a web browser configured to access information on the Internet by way of a network (e.g., the network 150). A browser application may launch one or more browser tabs in the context of one or more browser windows in the browser application. In some implementations, the operating system 254 is a Linux-based operating system configured to execute (or assist with executing) the unified television application 230.

The system 100 may include one or more server computers (e.g., the television application server 106, the LLM server 120, the advertising server 130) configured to interface with the mobile computing device 102, the media adapter 107, the media content providers 160, the network-connected display device 104, the user data repository 122, the demographic data repository 124, and the media content repository 128 by way of the network 150. In some implementations, the network 150 may establish a wireless communication link between the mobile computing device 102, the media adapter 107, the media content providers 160, the network-connected display device 104, the user data repository 122, the demographic data repository 124, and the media content repository 128.

The mobile computing device 102 may include the mobile computing device display 260. In some implementations, the mobile computing device display 260 is a display device such as a liquid crystal display (LCD), a light-emitting diode (LED) display, an organic light-emitting diode (OLED) display, or an active-matrix organic light-emitting diode (AMOLED) display. The network-connected display device 104 may include the display 246. In some implementations, the display 246 is a display device such as a liquid crystal display (LCD), a light-emitting diode display (LED) display, a plasma display, a quantum dot light-emitting diode display (QLED) display, or an organic light-emitting diode (OLED) display.

The LLM server 120 may include processor(s) 290, memory device(s) 292, and operating system (OS) 294. The advertising server 130 may include processor(s) 286, memory device(s) 278, and operating system (OS) 276. The processor(s) 256, the processor(s) 240, the processor(s) 270, the processor(s) 280, the processor(s) 286, and the processor(s) 290 may be formed in a substrate configured to execute one or more machine executable instructions or pieces of software, firmware, or a combination thereof. The processor(s) 256, the processor(s) 240, the processor(s) 270, the processor(s) 280, the processor(s) 286, and the processor(s) 290 may be semiconductor-based. For example, the processor(s) 256, the processor(s) 240, the processor(s) 270, the processor(s) 280, the processor(s) 286, and the processor(s) 290 may include semiconductor material that can perform digital logic.

The memory device(s) 252, the memory device(s) 242, the memory device(s) 272, the memory device(s) 282, the memory device(s) 278, and the memory device(s) 292 may include main memory that stores information in a format that can be read and/or executed by the processor(s) 256, the processor(s) 240, the processor(s) 270, the processor(s) 280, the processor(s) 286, and the processor(s) 290 respectively. The memory device(s) 242, the memory device(s) 272, the memory device(s) 282, the memory device(s) 278, and the memory device(s) 292 may include one or more random-access memory (RAM) devices and/or one or more read-only memory (ROM) devices.

The memory device(s) 242, the memory device(s) 272, the memory device(s) 282, the memory device(s) 278, and the memory device(s) 292 may store applications that, when executed by the processor(s) 256, the processor(s) 240, the processor(s) 270, the processor(s) 280, the processor(s) 286, and the processor(s) 290, respectively, perform operations. For example, the memory device(s) 242 may store the operating system 244 and the TV application 258 that, when executed by the processor(s) 240, may perform operations on the mobile computing device 102. For example, the memory device(s) 252 may store the operating system 254 and the unified television application 230 that, when executed by the processor(s) 256, may perform operations on the network-connected display device 104. For example, the memory device(s) 292 may store the operating system 244 and the LLM(s) 228.

In some implementations, the memory device(s) 282 may represent any kind of (or multiple kinds of) memory (e.g., RAM, flash, cache, disk, tape, etc.). In some implementations, the memory device(s) 282 may include external storage, e.g., memory physically remote from but accessible by the television application server 106. The television application server 106 may include one or more modules, engines, or applications representing specially programmed software. In some implementations, the television application server 106 may include the operating system 284, the server-side TV application 224, the UMP 218, the user representation creator 222, the prompt generator 250, the customized content service 220, the processor(s) 280, and the memory device(s) 282. For example, the memory device(s) 282 may store the operating system 284, the server-side TV application 224, the UMP 218, the user representation creator 222, the prompt generator 250, and the customized content service 220 that, when executed by the processor(s) 280, may perform operations on the television application server 106 to implement one or more of the methods and processes described herein.

In some implementations, the memory device(s) 292 may represent any kind of (or multiple kinds of) memory (e.g., RAM, flash, cache, disk, tape, etc.). In some implementations, the memory device(s) 292 may include external storage, e.g., memory physically remote from but accessible by the LLM server 120. The LLM server 120 may include one or more modules, engines, or applications representing specially programmed software. In some implementations, the LLM server 120 may include the customized content generator 226, the LLM(s) 228, and the memory device(s) 282. For example, the memory device(s) 282 may store the operating system 284, the customized content generator 226, and the LLM(s) 228. The customized content generator 226, when executed by the processor(s) 290, may perform operations on the LLM server 120 to implement one or more of the methods and processes described herein.

In some implementations, the memory device(s) 278 may represent any kind of (or multiple kinds of) memory (e.g., RAM, flash, cache, disk, tape, etc.). In some implementations, the memory device(s) 278 may include external storage, e.g., memory physically remote from but accessible by the advertising server 130. The advertising server 130 may include one or more modules, engines, or applications representing specially programmed software. In some implementations, the advertising server 130 may include an advertising (ad) stitcher 232, and the memory device(s) 278. For example, the memory device(s) 278 may store the operating system 276, and the ad stitcher 232. The ad stitcher 232, when executed by the processor(s) 286, may perform operations on the advertising server 130 to implement one or more of the methods and processes described herein.

The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within the network 150. The network 150 may further include any number of hardwired and/or wireless connections. The network 150 may be, for example, communications networks having one or more types of topologies, including but not limited to the Internet, intranets, local area networks (LANs), cellular networks, Ethernet, Storage Area Networks (SANs), telephone networks, and Bluetooth personal area networks (PAN). In some implementations, two or more devices in a sub-network may be coupled by way of a wired connection, while at least some of the devices in the same sub-network are coupled by way of a local radio communication network (e.g., ZigBee, Z-Wave, Insteon, Bluetooth, Wi-Fi and other radio communication networks).

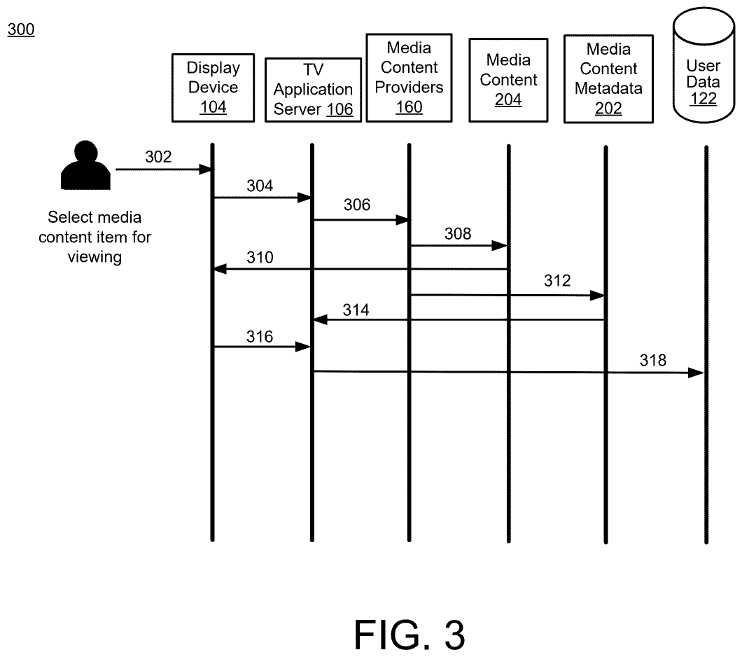

FIG. 3 is an illustration of an example swimlane diagram showing steps of a process 300 for obtaining information and data related to media content selected for viewing by a user (e.g., the user 101) according to implementations described throughout this disclosure. For example, referring to FIGS. 1A-C, and 2A-H, at step 302, the user 101 may interact with the user interface 115 of the unified television application 230 as displayed on the display 246 of the network-connected display device 104 and select a media content item for playing on the network-connected display device 104. At step 304, the unified television application 230 may send or provide information and data about the selected media content item (e.g., a title) to the television application server 106. At step 306, the television application server 106 may send or provide the information and data about the selected media content item to the media content providers 160. At step 308, a media content provider of the media content providers 160 may access the media content 204 in the media content repository 128 to obtain the media content item. At step 310, the media content item may be obtained from the media content 204 and sent or provided to the network-connected display device 104 for playing on the network-connected display device 104 for viewing by the user 101 on the display 246 of the network-connected display device 104. At step 312, the media content provider of the media content providers 160 may access the media content metadata 202 in the media content repository 128 to obtain information and data for the media content item. The information and data for the media content item may be metadata for the media content item. The metadata may include, but is not limited to, a title, genre(s), actor(s), a runtime, and a URL for the media content item. At step 314, the media content repository 128 may send or provide the metadata for the media content item selected for viewing by the user 101 to the television application server 106 (e.g., the customized content service 220).

At step 316, the unified television application 230 in the network-connected display device 104 may send additional information and data related to the viewing experience of the user 101 with the media content item to the television application server 106 (e.g., to the customized content service 220). For example, as described herein, the unified television application 230 in the network-connected display device 104 may send or provide a watch time for one or more periods, sections, chapters, or parts of the media content item to the server-side TV application 224 in the television application server 106. The server-side TV application 224 may provide the watch times for the determined periods of the media content item to the customized content service 220. The customized content service 220 may determine a genre for each watched period of the media content item. At step 318, the customized content service 220 in the television application server 106 may send or provide the genre for each watched period of the media content item and the metadata for the media content item to the user data repository 122.

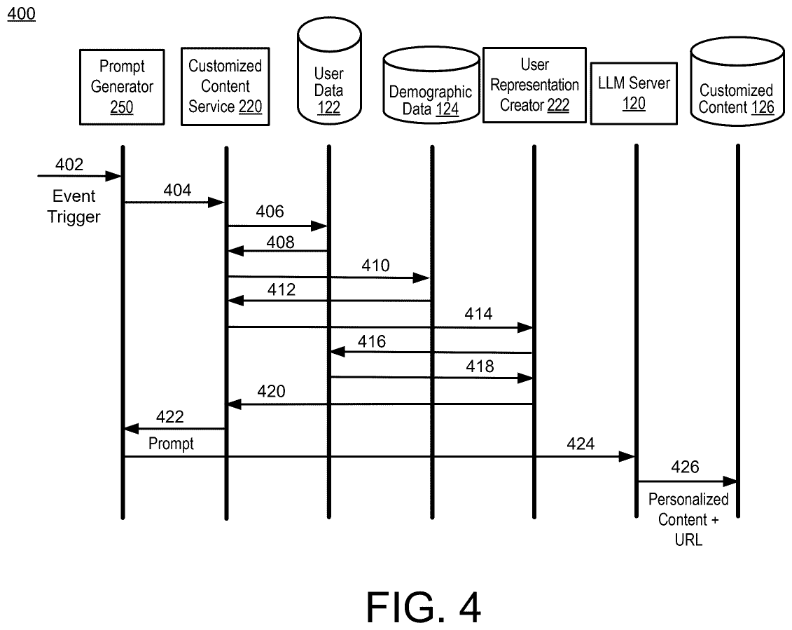

FIG. 4 is an illustration of an example swimlane diagram showing steps of a process 400 for generating customized media content for a user (e.g., the user 101) according to implementations described throughout this disclosure. For example, referring to FIGS. 1A-C, and 2A-H, the process 400 begins in response to the prompt generator 250 receiving an event trigger 402. For example, the event trigger 402 may be a request to start the process 400 entered into a user interface for the unified television application 230. For example, the event trigger 402 may be based on a time period (e.g., weekly, monthly, yearly). At step 404, the prompt generator 250 may provide a request to the customized content service 220 for information, data, and preferences of the user for use in creating a prompt for generating customized media content for the user. At step 406, the customized content service 220 may access the user data repository 122 to obtain information, data, and preferences of the user for use in creating the prompt. At step 408, the customized content service 220 may receive the requested information and data. At step 410, the customized content service 220 may access the demographic data repository 124 to obtain demographic data for the user for use in creating the prompt. At step 412, the customized content service 220 may receive the requested user demographic data. At step 414, the customized content service 220 may interface with the user representation creator 222 to obtain a digital representation of the user (e.g., an avatar of the user 101) for use in creating the prompt. At step 416, the user representation creator 222 may request a picture or image of the user from the user data repository 122 for use in generating a digital representation of the user. At step 418, the user representation creator 222 may receive the requested picture or image of the user from the user data repository 122 for use in generating a digital representation of the user. At step 420, the user representation creator 222 may create a digital representation of the user based on the received picture or image of the user and provide the digital representation of the user to the customized content service 220.

At step 422, the customized content service 220 provides the obtained information and data from the user data repository 122, the demographic data repository 124, and the digital representation of the user to the prompt generator 250. At step 424, the prompt generator 250 generates a prompt and sends or provides the prompt to the LLM server 120 for use by the customized content generator 226 to generate customized media content for the user. At step 426, the customized content generator 226 sends or provides the generated customized media content to the customized content repository 126 for storage along with a URL for the customized media content.

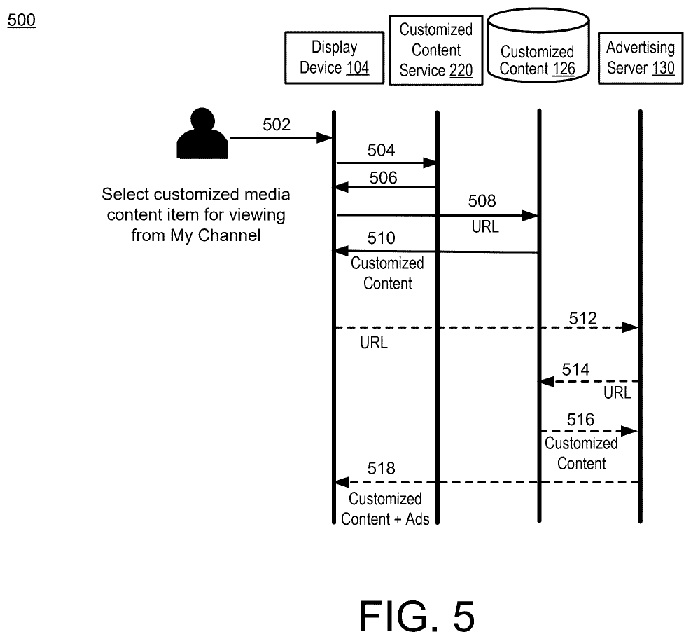

FIG. 5 is an illustration of an example swimlane diagram showing steps of a process 500 for providing a selection of customized media content to a television application (e.g., the unified television application 230) for viewing by a user (e.g., the user 101) according to implementations described throughout this disclosure. For example, referring to FIGS. 1A-C, and 2A-H, the unified television application 230 may present the user 101 with the user interface 117 in response to the selection of the my channel option 109 in the user interface 115 by the user 101. The user interface 117 may include a selection of generated customized media content items displayed as the tiles 110a-d for selection by the user 101. At step 502, the network-connected display device 104 (e.g., the unified television application 230) may receive a user selection of a tile (e.g., tile 110a) for a customized media content item that the user would like to view. At step 504, the network-connected display device 104 (e.g., the unified television application 230) may provide an indication of the selection of the tile (e.g., the tile 110a) to the customized content service 220 in the television application server 106. The customized content service 220 may determine a URL for the customized media content item selected for playing on the network-connected display device 104 for viewing by the user. For example, the URL for the customized media content item represented by the tile 110a may be stored in the customized content repository 126 in association with the customized media content item. At step 506, the customized content service 220 may send or provide the URL for the customized media content item to the network-connected display device 104 (e.g., the unified television application 230). At step 508, the unified television application 230 may send or provide the URL for the customized media content item to the customized content repository 126. At step 510, the customized media content item associated with the URL may be sent, provided, or streamed from the customized content repository 126 to the network-connected display device 104 for playing on the network-connected display device 104 for viewing by the user on the display 246.

In some implementations, at step 512, the unified television application 230 may send or provide the URL for the customized media content item to the advertising server 130. At step 514, the advertising server 130 may send or provide the URL for the customized media content item to the customized content repository 126. At step 516, the advertising server 130 may receive the customized media content item. At step 516, an ad stitcher 232 may insert one or more advertisements into the customized media content item received from the customized content repository 126. At step 518, the customized media content item with the added advertisements may be sent, provided, or streamed from the advertising server 130 to the network-connected display device 104 for playing on the network-connected display device 104 for viewing by the user on the display 246.

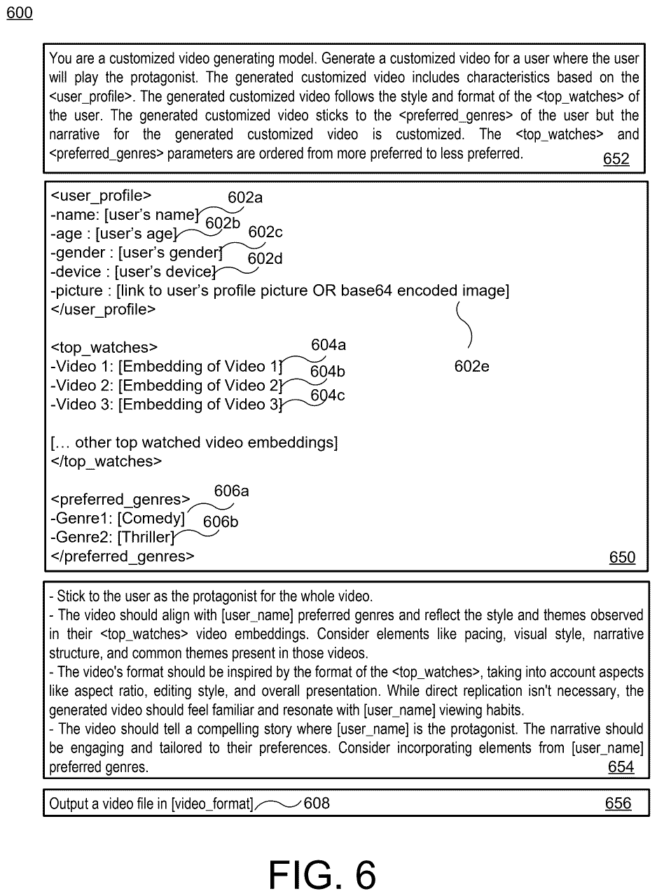

FIG. 6 is an illustration of an example static prompt 600 that includes a parameterized template 650 according to implementations described throughout this disclosure. In some implementations, the prompt generator 250 may generate a static prompt. For example, a prompt may include a parameterized template (e.g., the parameterized template 650). Parameters 602a-e, parameters 604a-c, and parameters 606a-bmay be data points for a user obtained by the customized content service 220 from the user data repository 122 and/or the demographic data repository 124 for use by the prompt generator 250. In the example parameterized template 650 the parameters 602a-e, 604a-d, and 606a-b are enclosed in brackets (e.g., [parameter value]). The static prompt 600 may include a preamble 652 that describes the task for the customized content generator 226. For example, based on the preference order of the parameters 604a-c, the user prefers watching Video 1 to watching Video 2. For example, based on the preference order of the parameters 706a-b, the user prefers comedy to thrillers. The static prompt 600 may include instructions 654 and a definition for an output format for the customized media content (output format 656 that includes parameter 608).

In some implementations, referring to the instructions 654, video embeddings may be compact numerical representations of video content that captures visual, audio, and temporal information. In general, generating video embeddings may include the use of frame-based methods (using pre-trained image models), three dimensional convolutional neural networks (3D CNNs) (for spatiotemporal processing), recurrent neural networks (RNNs) (for modeling temporal dynamics), and/or multimodal approaches that may combine visual, audio, and text data. For example, the video embeddings may be stored in vector-based databases.

The structured format of the static prompt 600 may provide benefits for users and developers. The structured format of the static prompt 600 may simplify the maintaining of the static prompt 600. The use of the parameterized template 650 may make the generating of the static prompt 600 for different users easier. In addition, or in the alternative, the use of the static prompt 600 may be easily adapted and controlled by a developer. However, if a user chooses not to allow the storing of data in the user data repository 122, the determining of the parameter values for including on the parameterized template 650 may be challenging. For example, the parameterized template 650 may not include values for all parameters and/or the parameterized template 650 may include default values for the parameter values. The lack of parameter values that reflect the preferences of the user may impact the experience of the user with the customized media content generated by the customized content generator 226 using the static prompt 600. In some implementations, when a new user-based feature is added, the developer may finetune or modify the static prompt 600.

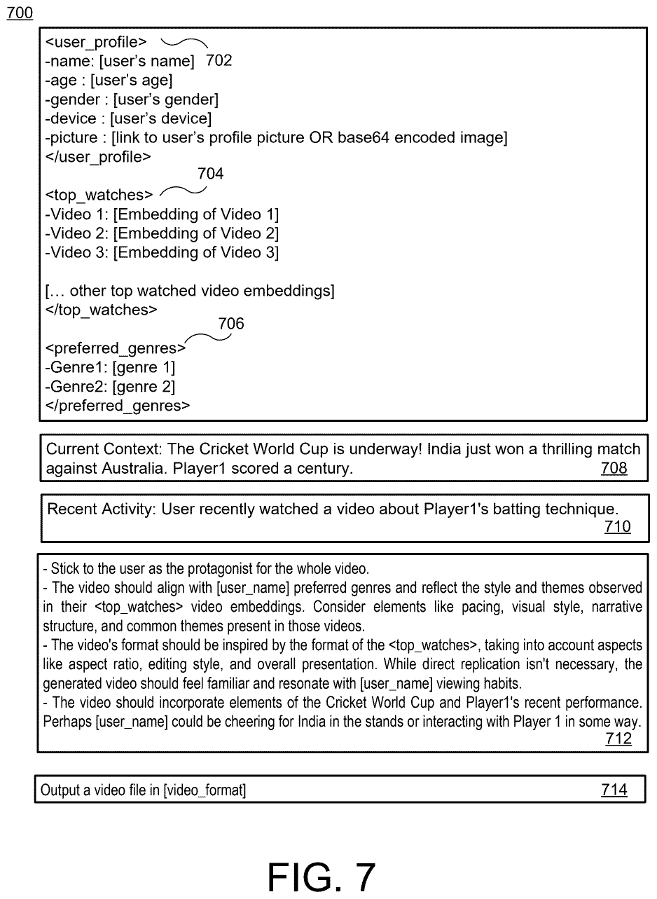

FIG. 7 is an illustration of an example model-based prompt 700 according to implementations described throughout this disclosure. In some implementations, the prompt generator 250 may generate a model-based prompt. In some implementations, a parameterized template included in a static prompt may be difficult to maintain when the number of parameters increases. In addition, or in the alternative, a parameterized template included in a static prompt may have reduced usefulness as a basis for generating customized media content for a user if the amount of information included in the parameterized template does not reflect or provide the preferences of the user.

In some implementations, in addition to, or as an alternative to, the use of the information and data reflective of the preferences of the user, the generating of customized media content may also be based on or incorporate current trends or recent news related to the interests and preferences of the user. For example, referring to FIGS. 1A-C, the user 101 may be a cricket fan and currently a major tournament is occurring. user's interests. In implementations that utilize a parameterized template in a static prompt, the static prompt may be regularly updated making customizing the media content based on real-time information difficult. For example, the parameterized template may be manually updated for a new tournament, player news, etc.

In some implementations, the prompt generator 250 may generate a model-based prompt for use by the customized content generator 226. For example, the prompt generator 250 may use a language model (e.g., a LLM included in the LLM(s) 228) to dynamically generate the prompt. For example, the prompt generator 250 may obtain contextual information for a user (e.g., <user_profile> parameters 702, <top_watches> parameters 704, <preferred_genres> parameters 706). In addition, or in the alternative, the prompt generator 250 may determine current events and/or trends. For example, the prompt generator 250 may obtain current contextual information 708 related to the interest of the user (e.g., cricket). The current contextual information 708 may be based on or include news articles, social media trends, and/or sports scores. In addition, or in the alternative, the prompt generator 250 may determine the recent activity of the user (e.g., recent activity 710). For example, the prompt generator 250 may determine the recent interactions of the user 101 with the unified television application 230 on the network-connected display device 104. For example, the prompt generator 250 may determine that the user 101 recently watched a video about a specific cricket player (e.g., Player1).

The customized media content recommendation system 100 may train and/or finetune a prompt generation model (e.g., a LLM included in the LLM(s) 228) for use by the prompt generator 250 for generating a prompt for use by the customized content generator 226 for generating customized media content for a user. For example, the input to the prompt generation model may include the <user_profile> parameters 702, the <top_watches> parameters 704, and the <preferred_genres> parameters 706 as well as the current contextual information 708 and the recent activity 710. The prompt generator 250 using the large language model may generate a prompt incorporating the information (e.g., model-based prompt 700) using instructions 712 and a definition for an output format for the customized media content (output format 714).

The implementing and use of the model-based prompt 700 may provide benefits for users and developers. The model-based prompt 700 may dynamically incorporate real-time information and trends for a user without the developer performing manual updates to a prompt for use in generating customized media content for the user. The model-based prompt 700 may be dynamically tailored to the user based on recent activates, preferences, and/or interests of the user. By training and using a prompt generation model, the customized media content recommendation system 100 may automate a prompt generation process by the prompt generator 250. Automating the prompt generation process may allow the customized media content recommendation system 100 to more easily handle many users. In addition, or in the alternative, automating the prompt generation process may allow the customized media content recommendation system 100 to more easily handle dynamic media content. As compared to the use of a static prompt as described with reference to FIG. 6, when using a model-based prompt 700 the customized media content recommendation system 100 may modify prompt generation logic dynamically without having to rewrite or update a parameterized template (e.g., the parameterized template 650). However, the use of a model-based prompt 700 may involve the maintaining of a large language model for use by the prompt generator 250 when generating a prompt for use by the customized content generator 226 when generating customized media content for a user. The use and maintaining of the large language model may increase an infrastructure cost for the customized media content recommendation system 100. For example, the customized media content recommendation system 100 may include additional processing units (e.g., tensor processing units) to implement the machine learning for training, using, and maintaining the large language model.

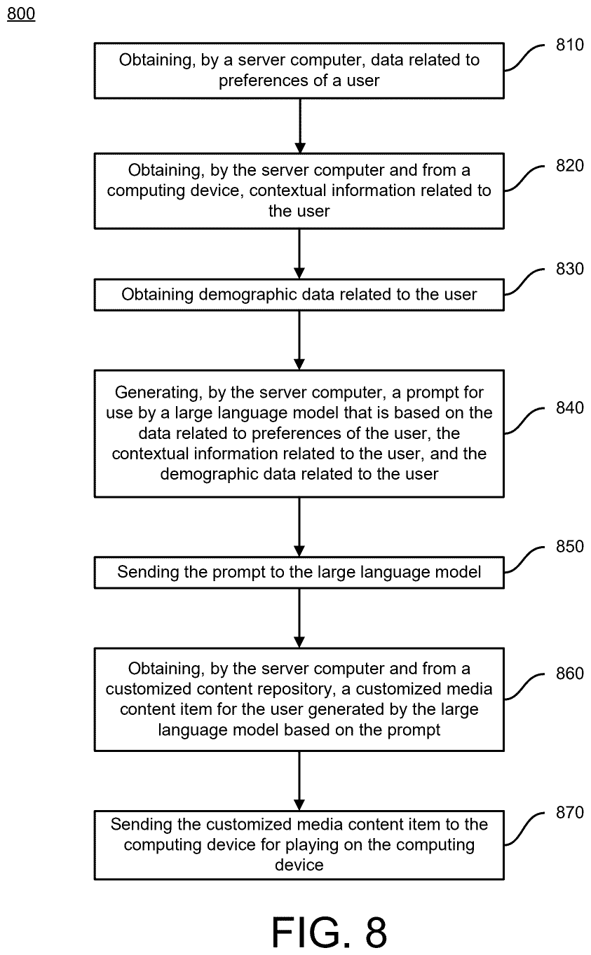

FIG. 8 illustrates a flowchart depicting example operations of generating customized media content according to implementations described throughout this disclosure. Although the flowchart 800 of FIG. 8 illustrates the operations in sequential order, it will be appreciated that this is merely an example, and that additional or alternative operations may be included. Further, operations of FIG. 8 and related operations may be executed in a different order than that shown, or in a parallel or overlapping fashion. The operations may define a computer-implemented method. Although the flowchart 800 is described with reference to the system 100 of FIG. 1C, the flowchart 800 may be executed according to any of the figures discussed herein. In some examples, the operations of the flowchart 800 are executed by the television application server 106.

Operation 810 includes obtaining, by a server computer, data related to preferences of a user.

Operation 820 includes obtaining, by the server computer and from a computing device, contextual information related to the user.

Operation 830 includes obtaining demographic data related to the user.

Operation 840 includes generating, by the server computer, a prompt for use by a large language model that is based on the data related to preferences of the user, the contextual information related to the user, and the demographic data related to the user.

Operation 850 includes sending the prompt to the large language model.

Operation 860 includes obtaining, by the server computer and from a customized content repository, a customized media content item for the user generated by the large language model based on the prompt.

Operation 870 includes sending the customized media content item to the computing device for playing on the computing device.

In some examples, the techniques described herein relate to a method including: obtaining, by a server computer, data related to preferences of a user; obtaining, by the server computer and from a computing device, contextual information related to the user; obtaining demographic data related to the user; generating, by the server computer, a prompt for use by a large language model that is based on the data related to preferences of the user, the contextual information related to the user, and the demographic data related to the user; sending the prompt to the large language model; obtaining, by the server computer and from a customized content repository, a customized media content item for the user generated by the large language model based on the prompt; and sending the customized media content item to the computing device for playing on the computing device.

In some examples, the techniques described herein relate to a method, wherein the data related to preferences of the user is obtained from a user data repository.

In some examples, the techniques described herein relate to a method, wherein the contextual information includes at least one of an Internet Protocol (IP) address of the computing device, a language of use by the computing device, and Global Positioning System (GPS) coordinates for the computing device.

In some examples, the techniques described herein relate to a method, further including sending the customized media content item to an advertising stitcher that inserts at least one advertisement into the customized media content item.

In some examples, the techniques described herein relate to a method, further including: receiving an event trigger; and based on receiving the event trigger, triggering the generating of the prompt.

In some examples, the techniques described herein relate to a method, wherein the prompt is generated without input from the user.

In some examples, the techniques described herein relate to a method, wherein the computing device is a first computing device of the user; wherein the contextual information related to the user includes information associated with the first computing device; wherein the customized media content item for the user generated by the large language model based on the prompt is a first customized media content item; and wherein sending the customized media content item to the computing device for playing on the computing device includes sending the first customized media content item to the first computing device for playing on the first computing device.

In some examples, the techniques described herein relate to a method, wherein the computing device is a second computing device of the user different from the first computing device; and wherein the contextual information related to the user includes information associated with the second computing device; wherein the customized media content item for the user generated by the large language model based on the prompt is a second customized media content item; and wherein sending the customized media content item to the computing device for playing on the computing device includes sending the second customized media content item to the second computing device for playing on the second computing device.

In some examples, the techniques described herein relate to a method, wherein the first computing device is a smart television and the second computing device is a mobile computing device.

In some examples, the techniques described herein relate to a method, further including: receiving, by the server computer and from the computing device, at least one parameter associated with the user; and based on receiving the at least one parameter associated with the user, generating, by the server computer, an updated prompt for use by the large language model based on the data related to preferences of the user, the contextual information related to the user, the demographic data related to the user, and the at least one parameter.

In some examples, the techniques described herein relate to a non-transitory computer-readable medium storing executable instructions that when executed by at least one processor of a server computer cause the at least one processor to execute operations, the operations including: obtaining, by the server computer, data related to preferences of a user; obtaining, by the server computer and from a computing device, contextual information related to the user; obtaining demographic data related to the user; generating a prompt for use by a large language model that is based on the data related to preferences of the user, the contextual information related to the user, and the demographic data related to the user; sending the prompt to the large language model; obtaining, by the server computer and from a customized content repository, a customized media content item for the user generated by the large language model based on the prompt; and sending the customized media content item to the computing device for playing on the computing device.

In some examples, the techniques described herein relate to a non-transitory computer-readable medium, wherein the data related to preferences of the user is obtained from a user data repository.

In some examples, the techniques described herein relate to a non-transitory computer-readable medium, wherein the contextual information includes at least one of an Internet Protocol (IP) address of the computing device, a language of use by the computing device, and Global Positioning System (GPS) coordinates for the computing device.

In some examples, the techniques described herein relate to a non-transitory computer-readable medium, further including sending the customized media content item to an advertising stitcher that inserts at least one advertisement into the customized media content item.

In some examples, the techniques described herein relate to a non-transitory computer-readable medium, wherein the operations further include: receiving an event trigger; and based on receiving the event trigger, triggering the generating of the prompt.

In some examples, the techniques described herein relate to a system including: at least one processor; and a non-transitory computer-readable medium storing instructions that when executed by the at least one processor cause the system to: obtain data related to preferences of a user; obtain contextual information related to the user; obtain demographic data related to the user; generate a prompt for use by a large language model that is based on the data related to preferences of the user, the contextual information related to the user, and the demographic data related to the user; send the prompt to the large language model; obtain a customized media content item for the user generated by the large language model based on the prompt; and send the customized media content item to a computing device for playing on the computing device.

In some examples, the techniques described herein relate to a system, wherein the data related to preferences of the user is obtained from a user data repository.

In some examples, the techniques described herein relate to a system, wherein the contextual information includes at least one of an Internet Protocol (IP) address of the computing device, a language of use by the computing device, and Global Positioning System (GPS) coordinates for the computing device.

In some examples, the techniques described herein relate to a system, further including sending the customized media content item to an advertising stitcher that inserts at least one advertisement into the customized media content item.

In some examples, the techniques described herein relate to a system, wherein the instructions when executed by the at least one processor further cause the system to: receive an event trigger; and based on receiving the event trigger, trigger the generating of the prompt.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

Further to the descriptions above, a user may be provided with controls allowing the user to make an election as to both if and when systems, programs, or features described herein may enable collection of user information (e.g., a user's preferences, a user's current location, a user's credentials, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

1. A method comprising:
obtaining, by a server computer, data related to preferences of a user;
obtaining, by the server computer and from a computing device, contextual information related to the user;
obtaining demographic data related to the user;
generating, by the server computer, a prompt for use by a large language model that is based on the data related to preferences of the user, the contextual information related to the user, and the demographic data related to the user;
sending the prompt to the large language model for use in generating a customized media content item for storing in a customized content repository;
obtaining, by the server computer and from the customized content repository, the customized media content item; and
sending the customized media content item to the computing device for playing on the computing device.

2. The method of claim 1, wherein the data related to preferences of the user is obtained from a user data repository.

3. The method of claim 1, wherein the contextual information includes at least one of an Internet Protocol (IP) address of the computing device, a language of use by the computing device, and Global Positioning System (GPS) coordinates for the computing device.

4. The method of claim 1,
wherein the method further comprises:
sending, by the server computer and to an advertising server, the customized media content item, wherein an advertising stitcher included in the advertising server generates an updated customized media content item by inserting at least one advertisement into the customized media content item; and
receiving, by the server computer and from the advertising server, the updated customized media content item; and
wherein sending the customized media content item to the computing device for playing on the computing device comprises sending the updated customized media content item to the computing device for playing on the computing device.

5. The method of claim 1, further comprising:
receiving an event trigger; and
based on receiving the event trigger, triggering the generating of the prompt.

6. The method of claim 1, wherein the prompt is generated without input from the user.

7. The method of claim 1,
wherein the computing device is a first computing device of the user;
wherein the contextual information related to the user includes information associated with the first computing device;
wherein the customized media content item for the user generated by the large language model based on the prompt is a first customized media content item; and
wherein sending the customized media content item to the computing device for playing on the computing device comprises sending the first customized media content item to the first computing device for playing on the first computing device.

8. The method of claim 7,
wherein the contextual information related to the user includes information associated with a second computing device of the user different from the first computing device;
wherein the customized media content item for the user generated by the large language model based on the prompt is a second customized media content item; and
wherein sending the customized media content item to the computing device for playing on the computing device comprises sending the second customized media content item to the second computing device for playing on the second computing device.

9. The method of claim 8, wherein the first computing device is a smart television and the second computing device is a mobile computing device.

10. The method of claim 1, further comprising:
receiving, by the server computer and from the computing device, at least one parameter associated with the user; and
based on receiving the at least one parameter associated with the user, generating, by the server computer, an updated prompt for use by the large language model based on the data related to preferences of the user, the contextual information related to the user, the demographic data related to the user, and the at least one parameter.

11. A non-transitory computer-readable medium storing executable instructions that when executed by at least one processor of a server computer cause the at least one processor to execute operations, the operations comprising:
obtaining, by the server computer, data related to preferences of a user;
obtaining, by the server computer and from a computing device, contextual information related to the user;
obtaining demographic data related to the user;
generating a prompt for use by a large language model that is based on the data related to preferences of the user, the contextual information related to the user, and the demographic data related to the user;
sending the prompt to the large language model for use in generating a customized media content item for storing in a customized content repository;
obtaining, by the server computer and from the customized content repository, the customized media content item; and
sending the customized media content item to the computing device for playing on the computing device.

12. The non-transitory computer-readable medium of claim 11, wherein the data related to preferences of the user is obtained from a user data repository.

13. The non-transitory computer-readable medium of claim 11, wherein the contextual information includes at least one of an Internet Protocol (IP) address of the computing device, a language of use by the computing device, and Global Positioning System (GPS) coordinates for the computing device.

14. The non-transitory computer-readable medium of claim 11,
wherein the operations further comprise:
sending, by the server computer and to an advertising server, the customized media content item, wherein an advertising stitcher included in the advertising server generates an updated customized media content item by inserting at least one advertisement into the customized media content item; and
receiving, by the server computer and from the advertising server, the updated customized media content item; and
wherein sending the customized media content item to the computing device for playing on the computing device comprises sending the updated customized media content item to the computing device for playing on the computing device.

15. The non-transitory computer-readable medium of claim 11, wherein the operations further comprise:
receiving an event trigger; and
based on receiving the event trigger, triggering the generating of the prompt.

16. A system comprising:
at least one processor; and
a non-transitory computer-readable medium storing instructions that when executed by the at least one processor cause the system to:
obtain data related to preferences of a user;
obtain contextual information related to the user;
obtain demographic data related to the user;
generate a prompt for use by a large language model that is based on the data related to preferences of the user, the contextual information related to the user, and the demographic data related to the user;
send the prompt to the large language model for use in generating a customized media content item for storing in a customized content repository;
obtain a customized media content item from the customized content repository; and
send the customized media content item to a computing device for playing on the computing device.

17. The system of claim 16, wherein the data related to preferences of the user is obtained from a user data repository.

18. The system of claim 16, wherein the contextual information includes at least one of an Internet Protocol (IP) address of the computing device, a language of use by the computing device, and Global Positioning System (GPS) coordinates for the computing device.

19. The system of claim 16,
wherein the instructions that when executed by the at least one processor further cause the system to:
send the customized media content item to an advertising server, wherein an advertising stitcher included in the advertising server generates an updated customized media content item by inserting at least one advertisement into the customized media content item; and
receive, from the advertising server, the updated customized media content item; and
wherein sending the customized media content item to the computing device for playing on the computing device comprises sending the updated customized media content item to the computing device for playing on the computing device.

20. The system of claim 16, wherein the instructions when executed by the at least one processor further cause the system to:
receive an event trigger; and
based on receiving the event trigger, trigger the generating of the prompt.
